(19) United States
(12) Patent Application Publication
(10) Pub. No.: US 2014/0287857 A1
(43) Pub. Date: Sep. 25, 2014

(54) POWER CUTTER WITH BELT COOLING

(71) Applicant: MAKITA CORPORATION, Aichi (JP)

(72) Inventor: Manfred DOERING, Neuhof (DE)

(21) Appl. No.: 14/219,482

(22) Filed: Mar. 19, 2014

(30) Foreign Application Priority Data
Mar. 20, 2013 (DE) 202013101193.2

(51) Int. Cl. F16H 57/04; F16H 7/02

(52) U.S. Cl. CPC F16H 57/0416; F16H 7/02
USPC 474/93

(57) ABSTRACT

A power cutter with an engine and with a cutting arm on which a cutting tool is received and is driven by the engine by way of a belt is provided. The belt may be received in a belt space formed in the cutting arm, and a fan wheel is arranged on the engine so that an air flow for cooling the engine can be generated. A combustion-air flow is provided to the engine, and the fan wheel provides an air circulation system where an air flow at least flows through the belt space and the combustion-air flow branches off from the air circulation system.

The present invention relates to a power cutter with an engine and with a cutting arm on which a cutting tool is received and is driven by the engine by way of a belt, wherein the belt is received in a belt space formed in the cutting arm, and wherein on the engine a fan wheel is arranged by means of which an air flow for cooling the engine can be generated, and wherein a combustion-air flow is provided which for operating the engine is made available to said engine.

### STATE OF THE ART

For example, DE 1 768 076 U1 shows a principle of a belt cooling device in which a combustion-air flow for the engine is guided through the belt space in which a belt drive is operated. However, this is associated with a disadvantage in that a considerable input of dirt into the belt space results, and consequently the belt drive may fail prematurely, or at least frequent changing of the belt becomes necessary.

From DE 83 22 094 U1 a V-belt pulley is known which at the same time is designed as a fan wheel. The design as a fan wheel has been implemented with the use of a blade arrangement on the V-belt pulley, by means of which blade arrangement an air vortex can be generated in the belt space, and air can flow from the interior side of the pulley to the belt, although said belt runs over the V-belt pulley. However, in an enclosed belt space, for example in the cutting arm of a power cutter, temperatures are essentially uniformly high, so that effective cooling of the belt merely by means of an air vortex generated in this manner is not possible.

DE 1 798 073 U1 shows an internal combustion engine for an engine-operated vehicle, wherein the engine housing at the same time serves as a transmission housing, and in a space a belt drive is accommodated in order to transmit a rotary movement of the engine shaft to a further shaft. On the engine a fan wheel is arranged by means of which an air flow through a conduit is generated, and the conduit extends from the fan wheel space to the space in which the belt drive is arranged. In this manner the space can be supplied with cooling air by means of the belt drive, and by way of an outlet opening the air conveyed into the space can subsequently escape. This makes it possible to cool the belt drive; however, the cooling air conveyed into the space is unfiltered, so that with this arrangement, too, the belt drive can disadvantageously become dirty.

The above-mentioned cooling systems for belt drives cannot be advantageously implemented in the case of a power cutter with an engine and with a cutting arm in which a belt space for accommodating a belt is formed. In particular, with the fan wheel an air flow both for cooling the engine and an air flow for cooling the belt need to be generated. Furthermore, a combustion-air flow is required that imperatively needs to be pre-filtered so that the engine does not get damaged during operation. In this arrangement it is, at the same time desirable in a simple manner to create belt cooling that is also generated by pre-filtered air.

### DISCLOSURE OF THE INVENTION

It is the object of the invention to improve a power cutter with a belt, which belt can be cooled in a simple manner without being subjected to dirt. In particular, it is the object of the invention to jointly use means for providing the combustion-air flow for operating the engine, and means for providing a cooling air flow for belt cooling.

This object is met based on a power cutter according to the precharacterising part of claim 1 in conjunction with the characterising features. Advantageous improvements of the invention are stated in the dependent claims.

The invention includes the technical teaching according to which by means of the fan wheel an air circulation system is formed by means of which an air flow at least through the belt space flows, and wherein from the air circulation system the combustion-air flow branches off.

The core of the invention consists of creating an air circulation system with the fan wheel on the engine of a power cutter from which several air flows can be provided. This results in a particular advantage in that with a single air circulation system it is possible to provide cooling of the belt, wherein from the same air circulation system the combustion-air flow for operating the engine can be provided by means of corresponding branching. The particular advantage is achieved by the dual use of filter systems, for example in order to provide a pre-filter stage for the combustion-air flow, which pre-filter stage can be followed by a further filter stage. At the same time it is possible, for cooling the belt, to directly use the air that is already available, pre-filtered, from the pre-filter stage.

According to an advantageous improvement the air circulation system can comprise a branching unit from which both a belt-cooling air flow and the combustion-air flow lead. The branching unit can comprise a filter device, and the filter device can form either a pre-filter stage or a fine-filter stage, and if the filter device is designed as a pre-filter stage, from it both the combustion-air flow and the air flow for cooling the belt can be led; and if the filter device is designed as a fine-filter stage, from the filter device the combustion-air flow can be conveyed directly to the engine without the need for a further filter element.

According to a first possible variant for implementing the invention, by way of a negative-pressure line the fan wheel can generate negative pressure in the branching unit, wherein the belt space is incorporated in the negative-pressure line, and wherein the negative-pressure line leads to the branching unit. By means of this variant a suction principle can be implemented in the air circulation system, and the air circulating in the air circulation system is essentially made to move as a result of negative pressure being generated. The negative-pressure line can extend between the fan wheel and the branching unit, wherein the negative-pressure line is connected to the fan wheel either directly or by way of corresponding means so that, by means of the fan, suction is created in the negative-pressure line. In this arrangement a first section of the negative-pressure line can extend between the fan wheel and the belt space, and a further section of the negative-pressure line can extend between the belt space and the branching unit. The flow of air through the negative-pressure line results in a belt-cooling air flow that is conveyed from the branching unit to the belt space. This results in cooling of the belt, and air heated by the belt can be conveyed from the belt space through the section of the negative-pressure line between the belt space and the fan wheel.

Furthermore advantageously, a cyclone separator can be arranged upstream of the branching unit, wherein ambient air can be sucked into said cyclone separator as a result of the negative pressure present in the branching unit. The cyclone separator arranged upstream of the branching unit results in the pre-cleaning of ambient air that enters the branching unit. Without any further filtering the pre-cleaned ambient air can serve as a belt-cooling air flow and can be channelled into the negative-pressure line in order to finally reach the belt space.

Moreover, it is advantageous that a separating line is provided that connects the cyclone separator to the fan wheel, wherein in particular in the separating line negative pressure can be generated by the fan wheel. As a result of this the cyclone separator effect in the cyclone separator is further improved. Furthermore, the filter device in the branching unit can be arranged in such a manner that only the combustion-air flow passes through it. This makes it possible to achieve minimum flow resistance of the belt-cooling air flow that, emanating from the cyclone separator, can pass through the branching unit before entering the negative-pressure line and by way of the aforesaid reaching the belt space. If the filter device is arranged in the branching unit in such a manner that only the combustion-air flow passes through the filter device, then the filter device in the branching unit serves as a fine-filter stage for the combustion air, which follows on from the cyclone separator that forms a pre-filter stage. Because negative pressure arises in the combustion-air line when the engine is operating, the combustion-air flow can be maintained already by this negative pressure, in particular in order to flow through the filter device in the branching unit.

According to a second possible variant for implementing the invention, the fan wheel can generate positive pressure in the branching unit, in particular by way of a positive-pressure line, wherein the belt-cooling air flow is guided through a cooling-air line from the branching unit to the belt space. In this arrangement the positive-pressure line can lead to the fan wheel in such a manner that the fan wheel generates positive pressure in the positive-pressure line. Consequently, as a result of the fan wheel, unfiltered air is conveyed through the positive-pressure line into the branching unit, and from the branching unit a cooling-air line for guiding the belt-cooling air flow can be branched off, which cooling-air line leads into the belt space; at the same time a combustion-air line can lead from the branching unit in order to guide a combustion-air flow to the engine of the power cutter.

Particularly advantageously a filter element can be arranged in the branching unit; in particular, the branching unit can comprise a cyclone filter. In the same manner the cyclone filter can supply both the cooling-air line and the combustion-air line in order to convey cooling air into the belt space and in order to convey combustion air to the engine. In the combustion-air line an air filter can be in place to form a fine-filter stage so that pre-filtering occurs in the branching unit, and the air filter in the combustion-air line can serve to provide particularly clean combustion air.

Likewise, in the suction variant, formed in this manner, for generating the circulating air in the air circulation system, from the belt space a suction line can lead to the fan wheel, wherein in the suction line negative pressure is generated by the fan wheel. Consequently, on the one hand, by way of the positive-pressure line, positive pressure can be generated that conveys air at positive pressure to the branching unit; and on the other hand, at the same time, a suction effect in the suction line can be used to further support circulation of the air in the air circulation system.

Irrespective of the design of the air circulation system as a pressure system or as a suction system, the air circulation system generates an air flow through the belt space, by means of which air flow the belt used for driving the cutting tool can be cooled. This design is associated with a particular advantage in that irrespective of the embodiment variant the air conveyed to the belt space has been pre-filtered, in particular by means of a cyclone separator. At the same time, irrespective of the arrangement of a negative-pressure line, of a separating line, of a positive-pressure line or of a further suction line the fan wheel can generate an air flow for cooling in particular the cylinder of the engine. The fan wheel, which can, for example, be designed as a magnet wheel of the engine can comprise several sections circumferentially distributed, with several air functions being associated with said sections. For example, by way of a segment of the fan wheel an air flow for cooling the engine can be generated; by way of a further segment negative pressure can be generated in a negative-pressure line; in the same manner in a further segment positive pressure can be generated in a positive-pressure line. This requires means that can generate either negative pressure or positive pressure in a line adjacent to the fan wheel, which means are implemented, for example, either as air baffles or as flow restrictions in order to generate positive pressure according to the principle of a build-up of air, or to generate negative pressure according to the principle of a venturi nozzle.

For understanding the present invention the notion of “lines for guiding the various air flows” is not limited to hose lines, pipelines or, for example, elongated conduits. For example, it is also possible for passages in housing walls or for transitions between various spaces to be referred to as “lines”. Thus, the cyclone separator can, for example, form an integral part of the branching unit, or the branching unit or the belt space can be directly adjacent to the fan wheel in order to build up a corresponding positive pressure or negative pressure, without there being any lines between them.

### PREFERRED EXEMPLARY EMBODIMENTS OF THE INVENTION

Further measures that improve the invention are presented in more detail below together with a description of preferred exemplary embodiments of the invention with reference to the figures. The following are shown:

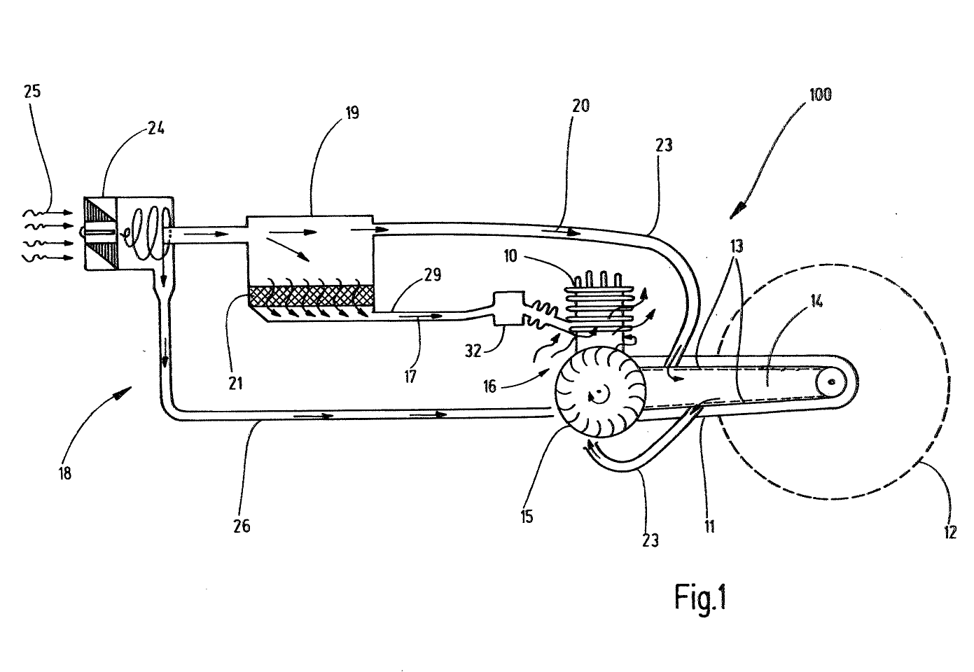

FIG. 1 a first variant of an air circulation system for a power cutter, wherein the air circulation system is designed as a suction system, and

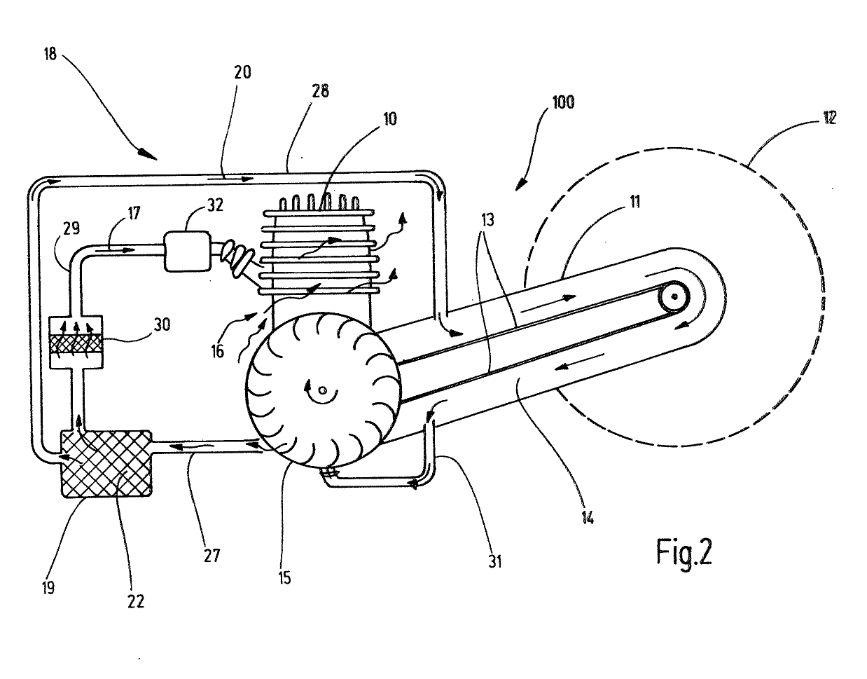

FIG. 2 a second variant of an air circulation system for a power cutter, wherein the air circulation system is designed as a pressure system.

FIG. 1 diagrammatically shows a first variant of a power cutter 100 with an engine 10 and with a cutting arm 11 on which a cutting tool 12 is received. In order to drive the cutting tool 12 with the engine 10 there is a belt 13 (shown diagrammatically) that extends between the engine 10 and the cutting tool 12. The belt 13 is accommodated in a belt space 14, wherein the belt space 14 is located in or on the cutting arm 11. For example, in a manner not shown in detail the belt space 14 can be situated in a trough-like indentation in the cutting arm 11, which indentation is closed off with the use of a cover element that can be arranged on the cutting arm 11. A fan wheel 15 (shown diagrammatically) is arranged on the engine 10, by means of which fan wheel 15 an air flow 16 for cooling the engine 10 can be generated, wherein the fan wheel 15 comprises, for example, a blade arrangement and can be designed as a magnet wheel of the engine 10. Furthermore, the engine 10 comprises a carburettor 32 to which a combustion-air line 29 leads, through which a combustion-air flow 17 is conveyed that is required for operation of the engine 10.

According to the invention, the combustion-air flow 17 forms part of an air circulation system 18. The air circulation system 18 is designed as a suction system and comprises several lines in which the belt space 14 is incorporated. Below, the function of the air circulation system 18, which is designed according to a suction principle, is described in more detail.

Due to rotation of the fan wheel 15 negative pressure is generated in the negative-pressure line 23. The negative-pressure line 23 leads into the belt space 14 so that as a result of negative pressure in the negative-pressure line 23 negative pressure is also generated in the belt space 14. The negative-pressure line 23 continues on a further side of the belt space 14 before leading into a branching unit 19. As a result of the negative pressure in the belt space 14 a belt-cooling air flow 20 is conveyed from the branching unit 19 to the belt space 14, as indicated by several arrows. Consequently a flow through the belt space 14 is generated, which flow finally results in the cooling of the belt 13.

A cyclone separator 24 is arranged upstream of the branching unit 19, and because of the negative pressure in the negative-pressure line 23 negative pressure is also generated in the branching unit 19. This negative pressure continues into the cyclone separator 24 so that ambient air 25 can be sucked into the cyclone separator 24. Furthermore, the diagram shows a separating line 26 that leads from the cyclone separator 24 to the fan wheel 15, and with a corresponding arrangement (not shown in detail) of the separating line 26 on the rotating fan wheel 15, negative pressure can also be generated in the separating line 26, and consequently the separation effect in the cyclone separator 24 is assisted.

Furthermore, a combustion-air line 29 is connected to the branching unit 19, through which combustion-air line 29 a combustion-air flow 17 can be conveyed from the branching unit 19 to the carburettor 32 of the engine 10. For the fine filtering of the combustion air for the engine 10 a filter device 21 is situated in the branching unit 19, which filter device 21 is, for example, designed as a paper filter or as a textile filter.

By means of the air circulation system 18, for the purpose of cooling the belt 13, cooling air that has been pre-filtered with the use of the cyclone separator 24 is provided to the belt space 14, and the combustion-air flow 17 as well as the belt-cooling air flow 20, has been pre-cleaned by a first filter stage with the use of the cyclone separator 24, and the combustion-air flow 17 is subjected to additional cleaning, in the branching unit 19, by the filter device 21. In this arrangement the filter arrangement 21 can also be arranged outside the branching unit 19, for example within the combustion-air line 29.

FIG. 2 shows a further variant of the power cutter 100 with an engine 10 and with a cutting arm 11 on whose end the cutting tool 12 is received and is driven by the engine 10 by way of the belt 13. The belt 13 is accommodated in the cutting arm 11 in a belt space 14 in order to drive the cutting tool 12. According to this variant, the air circulation system 18 shown is designed as a pressure system as described below.

By means of the fan wheel 15 driven by the engine 10 positive pressure is generated in a positive-pressure line 27, wherein said positive-pressure line 27 leads into a branching unit 19. A cooling-air line 28 leads from the branching unit 19, conveying a belt-cooling air flow 20 into the belt space 14. Furthermore, a combustion-air line 29 leads from the branching unit 19, through which combustion-air line 29 the combustion-air flow 17 is conveyed to the carburettor 32 of the engine 10.

The branching unit 19 comprises a filter device 22 that can be designed as a paper filter or a fabric filter; however, it is advantageously also possible for the filter device 22 to be designed as a cyclone separator. As a result of this the belt-cooling air flow 20 is pre-cleaned so that also according to the pressure principle shown pre-cleaned air is fed to the belt space 14. In the combustion-air line 29 an air filter 30 has been installed that is used as a fine-filter stage for filtering the combustion-air flow 17, wherein the filter device 22 in the branching unit 19 is used as a pre-filter stage.

Between the belt space 14 and the fan wheel 15 a suction line 31 is arranged, and in the outlet of the suction line 31 to the fan wheel 15 suction can be generated so that by way of the suction line 31 air can be sucked from the belt space 14. In this manner the pressure system can be supported in order to improve the air circulation in the air circulation system 18.

The fan wheel 15 serves in a known manner for cooling the engine 10 by means of an air flow 16, and the diagrammatic view according to the exemplary embodiment shows that, by way of various segments of the fan wheel 15, various suction effects and pressure effects can be generated. In this view the arrangement of the lines leading to the fan wheel 15 are shown diagrammatically only, and with reference to the direction of rotation of the fan wheel 15 the suction line 31 can, for example, be arranged downstream of the positive-pressure line 27 in order to convey air that is as cold as possible into the positive-pressure line 27.

In particular, fan wheels 15 with a front blade arrangement and a rear blade arrangement are known. It is thus also imaginable, irrespective of the design of the air circulation system 18 as a suction system or as a pressure system, on a first blade arrangement side of the fan wheel 15 to generate positive pressure, and on a further blade arrangement side of the fan wheel 15 to generate negative pressure. Irrespective of this, by means of one or both blade arrangements of the fan wheel 15 the air flow 16 for cooling the engine can be generated.

Implementation of the invention is not limited to the preferred exemplary embodiment stated above. Instead, a number of variants are imaginable, which variants make use of the solution presented, even in the case of fundamentally different designs. All the characteristics and/or advantages contained in the claims, the description or the drawings, including design details or spatial arrangements, may be significant in the context of the invention, either per se or in whatever combinations.

### LIST OF REFERENCE CHARACTERS

100 Power cutter

10 Engine

11 Cutting arm

12 Cutting tool

13 Belt

14 Belt space

15 Fan wheel

16 Air flow

17 Combustion-air flow

18 Air circulation system

19 Branching unit

20 Belt-cooling air flow

221 Filter device

22 Filter device

23 Negative-pressure line

24 Cyclone separator

25 Ambient air

26 Separating line

27 Positive-pressure line

28 Cooling-air line

29 Combustion-air line

30 Air filter

31 Suction line

32 Carburettor

1. A power cutter with an engine and with a cutting arm on which a cutting tool is received and is driven by the engine by way of a belt, wherein the belt is received in a belt space formed in the cutting arm, and wherein on the engine a fan wheel is arranged by means of which an air flow for cooling the engine can be generated, and wherein a combustion-air flow is provided which for operating the engine is made available to said engine, characterised in that by means of the fan wheel an air circulation system is formed by means of which an air flow at least through the belt space flows, and wherein from the air circulation system the combustion-air flow branches off.

2. The power cutter according to claim 1, characterised in that the air circulation system comprises a branching unit from which a belt-cooling air flow and the combustion-air flow lead.

3. The power cutter according to claim 2, characterised in that the branching unit comprises a filter device.

4. The power cutter according to claim 1, characterised in that by way of a negative-pressure line the fan wheel generates negative pressure in the branching unit, wherein the belt space is incorporated in the negative-pressure line, and wherein the negative-pressure line leads to the branching unit.

5. The power cutter according to claim 1, characterised in that a cyclone separator is arranged upstream of the branching unit, wherein ambient air can be sucked into said cyclone separator as a result of the negative pressure present in the branching unit.

6. The power cutter according to claim 5, characterised in that a separating line is provided that connects the cyclone separator to the fan wheel, wherein in particular in the separating line negative pressure is generated by the fan wheel.

7. The power cutter according to claim 3, characterised in that the filter device in the branching unit is arranged in such a manner that only the combustion-air flow passes through it.

8. The power cutter according to claim 1, characterised in that the fan wheel generates positive pressure in the branching unit, in particular by way of a positive-pressure line, wherein the belt-cooling air flow is guided through a cooling-air line from the branching unit to the belt space.

9. The power cutter according to claim 8, characterised in that the branching unit comprises a cyclone filter.

10. The power cutter according to claim 8, characterised in that the combustion-air flow is conveyed through a combustion-air line between the branching unit and the engine, wherein the combustion-air line comprises an air filter.
